(19) United States
(12) Patent Application Publication
(10) Pub. No.: US 2013/0170315 A1
(43) Pub. Date: Jul. 4, 2013

(54) Container of a Biogas System and Method for Removing a Component from the Container

(71) Applicant: Christoph Martens, Ostereistedt (DE)

(72) Inventor: Christoph Martens, Ostereistedt (DE)

(73) Assignee: MT-ENERGY GMBH, Zeven (DE)

(21) Appl. No.: 13/516,064

(22) PCT Filed: Dec. 16, 2010
(86) PCT No.: PCT/EP10/07665

§ 371 Date: Jul. 31, 2012

(30) Foreign Application Priority Data
Dec. 16, 2009 (DE) 10 2009 060 115.5

(51) Int. Cl. B01F 15/00

(52) U.S. Cl. CPC B01F 15/0072
USPC 366/242

(57) ABSTRACT

The invention relates to a container of a biogas system, comprising a component which may be removed from the container, for example an agitator for mixing substrate located in the container, a removal opening, as well as a removal device with which the component may be removed at least partially through the removal opening out of the container, for example for maintenance purposes, the removal device comprising a flexible hose which may be fastened with its first end to the removal opening, such that between the container interior and the hose interior a connection which is fluid-tight relative to the outside is present, through which the component may be at least partially guided into the hose, the removal device comprising a closure device by which the hose may be closed in a fluid-tight manner in the state fastened to the removal opening, and the removal device comprising a constricting device by which the hose may be constricted by reducing the hose cross section in the state fastened to the removal opening, when a component is inserted at least partially into the hose in the region of its first end facing the container, so that when the hose is closed a space is produced in the hose interior which is fluid-tight relative to the surroundings and at least partially receives the component.

### CROSS-REFERENCE TO RELATED APPLICATIONS

This application is a national stage application of PCT/EP20101007665, filed on Dec. 16, 2010, the entire contents of which are hereby incorporated by reference.

### STATEMENT REGARDING FEDERALLY SPONSORED RESEARCH

Not applicable.

### BACKGROUND OF THE INVENTION

The invention relates to a container of a biogas system, comprising a component which may be removed from the container, for example an agitator for mixing substrate located in the container, a removal opening, as well as a removal device with which the component may be removed at least partially through the removal opening out of the container for maintenance purposes. The invention also relates to a method for at least partially removing a component, for example an agitator for mixing substrate located in a container of a biogas system, from the container through a removal opening of the container, for example for maintenance purposes.

Fermentation and storage containers of biogas systems are provided with removable components, such as agitators. Depending on the design, one or more agitators may be provided in a container. Known agitators may considerably differ in type. An approximate differentiation may be made between agitators with a (submersed) drive unit located in the container (submersible motor-driven agitators), on the one hand, and agitators with an externally located drive unit, on the other hand. Further features of the agitators are, for example, the propeller size and rotational speed of a propeller used for mixing. So-called “giant paddles” are generally externally driven, highly geared-down paddle agitators which ensure a continuous mixing process by slow paddle movements in the container. Conventional submersible motor-driven agitators, however, have a relatively small propeller diameter of between, for example, 0.6 m and 1.2 m and are generally operated in intermittent operation and at high rotational speeds for mixing the substrate. In between said agitators so-called large-blade agitators exist, which are operated with a propeller diameter of between, for example, 1.6 m and 3 m within an average rotational speed range. In this case, the mixing process may take place continuously or in intermittent operation. In principle, the drive is selectively implemented via an external drive unit or a drive unit arranged in the container.

Moreover, dome-shaped agitators which are fastened to the top of the container are known. Generally, a large-blade agitator or a paddle agitator is introduced through the top of the container into the container and driven at least by a drive unit located outside the container. Such agitators are disclosed, for example, in DE 20 2004 004 101 U1 and DE 20 2006 020 195 U1. Agitators introduced from the side are also known. In this case, propeller agitators may be introduced from the side into the container via lances. Frequently, there is the possibility of pivoting the lance with the propeller on the tip within a certain radius. The drive may be implemented externally or may also be arranged on the tip of the lance. It is also possible to mount the lance in the container a second time and to arrange the agitator propeller on the shaft. A pivoting function is then, however, no longer provided. Such a design is, for example, disclosed in EP 1 619 239 A2. Paddle agitators may also be introduced from the side, but generally have a second bearing block with an abutment inside the container. Such agitators are disclosed, for example, in DE 20 2008 010 638 U1 and WO 2007/110064 A1. Agitators fastened in the interior of a container are also known. A frequently used construction is to mount submersible motor-driven agitators with a propeller directly in the container. Various options are available for the mounting. Frequently used are mountings consisting of an agitator mast which is mounted parallel to the outer wall of the container and is located vertically in the interior of the container. A submersible motor-driven agitator is fastened to the agitator mast via a bearing block, said agitator being able to be vertically adjusted via a pull cable. The agitator is pivotable via the agitator mast which is rotatable about its longitudinal axis. Both the vertical adjustment and the pivoting may be operated from the outside.

In order to be able to undertake maintenance on the agitator systems, in particular, the container generally has to be opened. According to DE 197 32 198 C1, DE 197 14 342 C1 and DE 20 2004 011 561 U1 flaps are provided to this end, through which maintenance may be carried out. Recesses in the concrete shell of the container are also possible. In some cases, it is necessary to empty the container partially or completely for the maintenance of the agitator. This is undesirable. Moreover, in the known systems, gas escapes from the container during the course of the maintenance. This is not acceptable from the environmental and operational safety point of view but even less so from the economic point of view, as regards ever-increasing fermentation volumes.

In EP 1 992 405 A1 it is proposed to arrange a chamber on the container wall, into which a conveying element may be retracted and which may be sealed after retracting the conveying element in a liquid-tight or fluid-tight manner. The chamber is opened or closed via a shut-off element arranged between the chamber and the container interior in the form of a slide. The chamber may be formed by a fastening device fastened to the container and to which the conveying device is fastened in turn. The fastening device comprises an intermediate plate in which a drive shaft of the conveying device is guided. On its side remote from the container, the intermediate plate is connected by screws to a motor of the conveying device. By releasing the screws, the conveying device may then be detached from the fastening device and a propeller of the conveying device withdrawn into the chamber defined by the intermediate plate, a connecting element and the slide. This device, however, is complex in terms of construction and thus expensive. Moreover, the operation of this device is complex. In addition, the known device together with the conveying device is arranged locally fixed to the container wall and has a small degree of flexibility with regard to the maintenance of different types of agitators.

Based on the cited prior art, the object of the invention is to provide a container and a method of the aforementioned type with which a component, for example an agitator, may be removed from the container, for example for maintenance, in a flexible and universal manner without impairing the operation of the system and without gas being able to escape in large quantities.

For a container of the type mentioned in the introduction, the object of the invention is achieved in that

the removal device comprises a flexible hose which may be fastened with its first end to the removal opening, for example a maintenance opening, such that between the container interior and the hose interior a connection which is fluid-tight relative to the outside is present, through which the component may be at least partially guided into the hose

the removal device comprises a closure device by which the hose may be closed in a fluid-tight manner in the state fastened to the removal opening, and

the removal device comprises a constricting device by which the hose may be constricted by reducing the hose cross section in the state fastened to the removal opening, when a component is inserted at least partially into the hose in the region of its first end facing the container, so that when the hose is closed a space is produced in the hose interior which is fluid-tight relative to the surroundings and at least partially receives the component.

For a method of the type mentioned in the introduction, the object of the invention is achieved by the steps:

a flexible hose is fastened with its first end to the removal opening such that between the container interior and the hose interior a connection is made which is fluid-tight relative to the surroundings,

the hose is closed in a fluid-tight manner,

the component is guided through the removal opening at least partially into the hose,

the hose is constricted in the region of its first end facing the container, when the component is inserted at least partially into the hose, by reducing its cross section, so that a space is produced in the hose which is fluid-tight relative to the surroundings and at least partially receives the component, and

the hose is opened, so that the component located at least partially in the hose is accessible, for example is able to be maintained.

It is possible that the hose comprises a second opening which may be closed by the closure device in a fluid-tight manner in the state fastened to the removal opening for closing the hose. The hose may also be constricted by means of the constricting device such that, when the second opening is closed, the space is produced in the hose interior which is fluid-tight relative to the surroundings and at least partially receives the component. For example, an opening extending in the longitudinal direction of the hose is conceivable as a second opening which, for example, may be opened and closed by means of a tear closure or a different closure device.

It is also possible that, for closing the hose by means of the closure device, the second end of the hose remote from the container interior may be closed in a fluid-tight manner in the state fastened to the removal opening. Accordingly, the hose may be constricted by means of the constricting device such that, when the second end is closed, the space is produced in the hose interior which is fluid-tight relative to the surroundings and at least partially receives the component.

Insofar as the component is an agitator, said agitator may be removed from the container together with its holder. The container according to the invention may, in particular, be a fermentation or storage container. Accordingly, the substrate may be a fermentation substrate. The container has a removal opening, for example a maintenance opening, through which the component, for example the agitator, may be removed for maintenance purposes or other purposes. During operation of the system, the removal opening may, for example, be closed by means of a flap or the like. The flap is opened for maintenance. For removal of the component from the container for maintenance purposes, according to the invention, a removal device is provided which comprises a hose made of a flexible film, for example a plastics film. The hose may initially be open at both ends. With its one end the hose may then be fastened to the removal opening. By means of the closure device, the hose, in particular a second opening or the hose end remote from the container interior in the mounted state, may, in particular, be closed in a fluid-tight manner and, in particular, also reopened. Naturally, for example during manufacture, said hose end could also be (permanently) closed and the hose cut for opening said end, for example. However, a closure device is preferred with which the hose, in particular a second opening or the second end of the hose, may be repeatedly closed and reopened. Relevant in this case are, for example, a gas-tight tear closure or a clamp closure. Reference is made to the fact that the hose, in particular a second opening or the end of the hose remote from the container interior, may be closed in a fluid-tight manner before or after fastening the hose to the removal opening. “Closed in a fluid-tight manner” means that no fluid is able to flow through the hose, in particular a second opening or the relevant hose end. It is also possible for a further part of the component to be removed to protrude through the fluid-tight closed end, but when closed the hose bears sealingly against the periphery of said part, for example a drive shaft of an agitator.

After closing the hose, in particular the second opening or the second hose end, and after fastening the hose to the removal opening, the component may be guided at least partially out of the container interior into the hose and also the first end facing the container constricted in a fluid-tight manner, so that no more fluid is able to flow through this end. Insofar as the component is an agitator, said agitator may be guided with or without its holder, but as a whole at least partially in the hose. A constricting device is provided for constricting the first hose end according to the invention. If the component to be removed is located fully in the hose, the hose cross section is correspondingly fully constricted. If, however, a part of the component is still in the container, the hose is constricted around the part of the component protruding from the container, for example a drive shaft or a holder of an agitator, the hose bearing sealingly against said part and thus producing the seal of the hose interior relative to the surroundings. By means of the constricting device, the seal may be achieved in a particularly simple manner. By releasing the constriction, the hose end, in turn, may be reopened in a particularly simple manner. After constricting the first end, the hose, in particular its second opening or the second end of the hose, is opened so that the component located in the hose is accessible for maintenance or the like.

The hose thus forms a sluice gate for feeding the component out of the container interior, by which the transition from the container interior into the surroundings is made possible, both spaces always being separated from one another. In this case, only a minimum quantity of biogas escapes from the container as the first hose end is constricted in a fluid-tight manner. In particular, only the gas volume located in the hose is able to escape. Therefore, the operation of the biogas system according to the invention is practically not affected. At the same time, by the use of a constricting device and a flexible hose the closing and opening of the hose is particularly simple and thus also cost-effective with regard to construction and operation. Costly fastening devices as in the prior art are not required according to the invention.

Also the component to be removed according to the invention is not fixedly connected to the removal device. For this reason and due to the easy mountability, the removal device according to the invention may be used in a flexible manner for the most varied types of components, for example agitators and containers. This applies irrespective of the size of the components or whether, for example, they are agitators with a drive unit arranged in the container or outside the container. For example, this also applies irrespective of whether, for example, an agitator is an agitator introduced from the side or from the top into the container or whether parts of the agitator are movable, for example displaceable or pivotable, in the container. Naturally, a plurality of components such as agitators may also be provided in the container according to the invention. Accordingly, a plurality of removal devices may also be provided.

According to a further embodiment, it is possible for the hose to be able to be fastened and/or to be fastened releasably to the removal opening. As a result, the hose may be removed during normal operation and only has to be fastened for maintenance to the container. It is then possible in a flexible manner to use the same removal device for the maintenance of components of different containers. According to a further particularly practical embodiment, it is possible for the hose to be able to be fastened to the edge of the removal opening by means of a welded connection.

The closure device may also be a constricting device by which the hose may be constricted in a fluid-tight manner, in particular in the region of its second end, by reducing the hose cross section. By releasing the constriction, the hose may be reopened, in particular the second end. In this manner, the closure device is of particularly simple configuration in terms of construction and thus easy to operate and cost-effective. This embodiment is particularly advantageous if the component protrudes partially out of the container and the second end of the hose is closed around this part of the component, i.e. in the closed fluid-tight state the component still protrudes partially from the second hose end.

The constricting device used according to the invention may comprise a constricting strap or a constricting clamp. For example, with a constricting strap the open end(s) of the hose may be releasably constricted in a particularly simple manner and thus sealed against the passage of fluid.

Depending on the design of the component to be removed, the removal opening may be arranged in the container wall or in a container cover, for example a film cover. In such containers, frequently (dual) membrane film covers are used. Provided the opening is arranged in the film cover, the covering film may also itself form the hose.

An evacuation device may also be provided with which the fluid-tight space may be evacuated, for example via a pump. Then, after constricting the hose in the region of its first end facing the container the fluid-tight space produced may be evacuated, for example by means of a pump. Then the hose may be opened, in particular its second opening or the second end of the hose remote from the container interior. By means of the evacuation, the hose fits snugly against the component located in the space. In this manner it is ensured that by means of the sluice gate according to the invention, practically no gas, or in any case only a small quantity of gas, is able to escape from the container into the surroundings.

For example, in agitators in which a part of the agitator and/or the holder protrudes from the container during operation, the flexible hose may be initially pushed with its two ends over the part of the agitator and/or the holder protruding from the container, the hose being able to be pushed together. Then the hose may be constricted in the region of its second end remote from the container around the part protruding from the container and the second end closed in this manner in a fluid-tight manner. After or before the closure of the second end, the first end of the hose may be fastened to the edge of the removal opening and the agitator then at least partially guided out of the container through the removal opening. At the same time, the hose is pushed together again. As soon as the agitator has been guided out of the container to the desired extent, the hose may be constricted in the region of its first end, so that a fluid-tight space for the agitator is present in the hose. Subsequently, the second end of the hose may be opened and the agitator, for example, made accessible for maintenance.

### BRIEF DESCRIPTION OF THE SEVERAL VIEWS OF THE DRAWINGS

An exemplary embodiment of the invention is explained in more detail hereinafter with reference to the figures in which schematically:

FIG. 1 shows a detail of a sectional view of a container according to the invention according to a first exemplary embodiment in three operating states,

FIG. 2 shows a detail of a sectional view of a container according to the invention according to a second exemplary embodiment in four operating states,

FIG. 3 shows a detail of a sectional view of a container according to the invention according to a third exemplary embodiment in four operating states.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

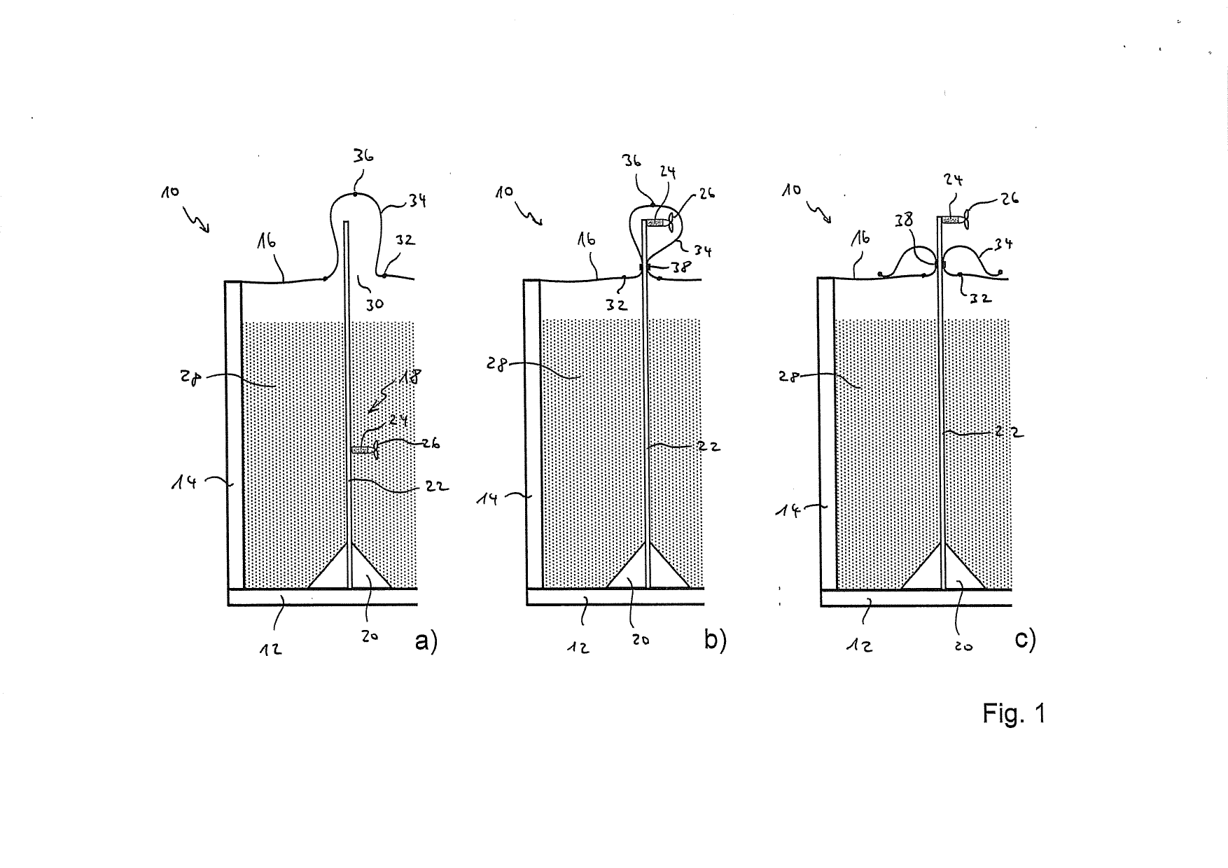

Provided nothing further is disclosed, the same reference numerals denote the same objects in the figures. In FIG. 1, in the partial views a), b) and c) in each case is shown a detail of a container 10 according to the invention in a vertical sectional view. The container 10 has a concrete base 12 and a peripheral concrete wall 14 which is circular in cross section, so that overall it has a cylindrical shape. At its upper end, the container 10 has a film cover 16. The container 10 in the example shown in FIG. 1 also has a component 18 which may be removed from the container, namely a submersible motor-driven agitator 18 with a vertical agitator mast 22 supported on the container base 12 by supports 20. An agitator drive 24 with a propeller 26 is mounted on the agitator mast 22 in a vertically displaceable manner. Via the drive 24, the propeller 26 may be rotated and thus substrate located in the container 28 may be mixed. The film cover 16 is provided with a maintenance opening 30. Via an approximately circular peripheral welded connection 32, a flexible hose 34 of a removal device for at least partial removal of the agitator 18 from the container 10 is fastened with its first end to the edge of the opening. Its second end remote from the container interior is closed in a fluid-tight manner by a closure device 36, in this case a gas-tight tear closure or a clamp attachment in the operating states shown in the partial views a) and b). The welded connection 32 is also fluid-tight so that in the partial view shown in a), in the hose interior gas may pass from the container 10 through the opening 30, without being able to flow into the surroundings.

For the maintenance of the agitator, in the example shown in FIG. 1 the submersible motor-driven agitator with its drive 24 and its propeller 26 is initially moved vertically upwards along the agitator mast 22 and through the opening 30 into the interior of the hose 34. Then, by means of a constricting device 38, in the present case a constricting strap 38, in the region of its first end facing the container interior by reducing the hose cross section the hose 34 is constricted around the agitator mast 22 in a fluid-tight manner. This is shown in the partial view b). As a result, a space is formed in the hose 34 which is fluid-tight relative to the surroundings and receives the drive 24 and the propeller 26 of the agitator. Then the hose 34 at its second end remote from the container interior is opened by the closure device 36 being released. As a result, the drive 24 and the propeller 26 are released for maintenance. This may take place without emptying the container 10 and, in particular, without a noticeable escape of gas. This is shown in FIG. 1 in the partial view c).

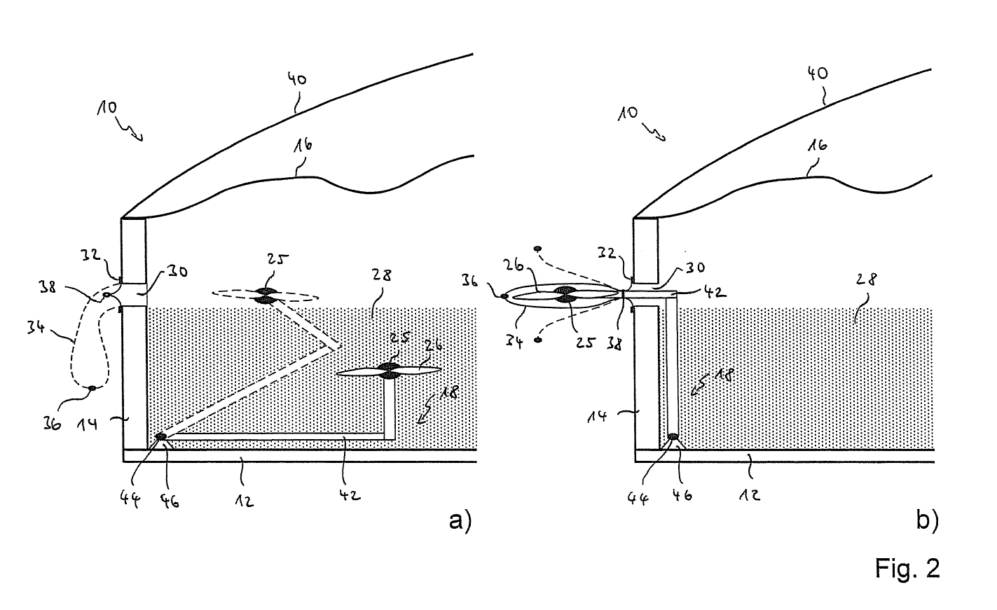

In FIG. 2, in the partial views a) and b) two operating states of a container 10 according to the invention are shown according to a further exemplary embodiment. In principle, this container 10 corresponds to the container 10 shown in FIG. 1. In contrast to the container of FIG. 1, however, in FIG. 2 an outer film cover 40 of the container is additionally shown. Moreover, in contrast to FIG. 1 in the container according to FIG. 2 a maintenance opening 30 is provided in the side container wall 14. In contrast to the embodiment according to FIG. 1, the agitator 18 according to FIG. 2 is also mounted on the edge of the container base 12 and has a propeller 26 which is drivable via a drive 25 and which is retained on one end of an L-shaped pivoting arm 42. At its other end, the pivoting arm 42 is pivotably mounted via a pivot bearing 44 on a base support 46.

For maintenance of the agitator, a flexible film hose 34 may be fastened in a fluid-tight manner with its one end to the outer edge of the maintenance opening 30, for example by means of a welded connection 32. In normal operation of the container 10, the film hose 34 may be packed up, for example rolled up. For maintenance, the hose 34 is then unpacked, as is illustrated by the dotted view of the hose 34 in the partial view a). The hose 34 is attached via the welded connection 32 in a fluid-tight manner to the edge of the maintenance opening 30. The opposing second hose end is in turn closed in a fluid-tight manner by a closure device 36 in the form, for example, of a tear closure or a clamp attachment. Then the propeller 26 of the agitator 18, by means of the pivoting arm 42, is pivoted in the direction of the maintenance opening 30, as is illustrated in dotted lines in the partial view a). By a suitable rotation of the propeller 26 and a further pivoting of the pivoting arm 42, the propeller 26 may then be guided through the maintenance opening 30 into the film hose 34. Then by means of a constricting strap 38, the first end of the hose 34 facing the container interior may be constricted in a fluid-tight manner around the pivoting mast 42. This operating state is shown in the partial view b) of FIG. 2. In the hose 34, a space which is sealed in a fluid-tight manner is now formed which receives the propeller 26. Subsequently, in turn the closure device 36 may be opened so that the propeller 26 is accessible for maintenance.

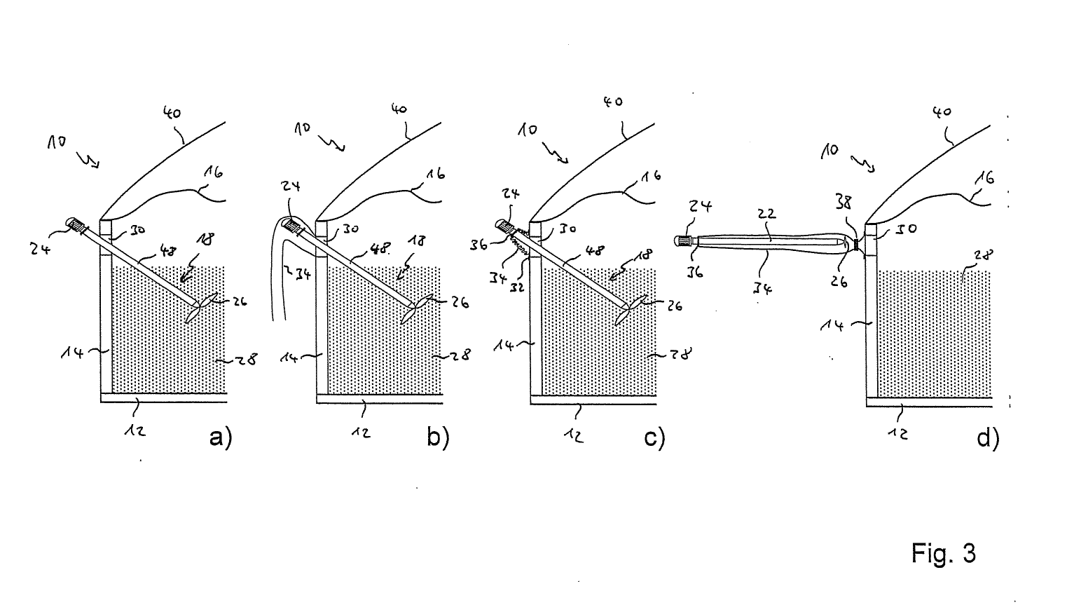

In FIG. 3, in the partial views a), b), c) and d) four operating states of a container 10 according to a third exemplary embodiment are shown. The container 10 according to FIG. 3 corresponds substantially to the container 10 shown in FIG. 2. However, the agitator 18 according to FIG. 3 differs from the agitator shown in FIG. 2. Thus the agitator 18 according to FIG. 3 in the operating state shown in the partial view a) has a drive shaft 48 extending through the maintenance opening 30 at an angle to the vertical in the container interior and, in particular, in the substrate 28, said drive shaft at its one end having an agitator propeller 26. In the operating state shown in the partial view a), the agitator 18, and in particular the drive shaft 48, protrudes through the maintenance opening 30 and thus through the container wall 14 out of the container 10. On its side remote from the propeller 26, the drive shaft 48 carries an agitator drive 24 via which the propeller 26 may be driven for mixing the substrate 28. In this case it is a lance-type agitator guided from the side through the wall, with an externally located drive unit. For maintenance of said agitator 18, a film hose 34 which is not mounted in the container 10 during normal operation, may be pulled from outside initially via the part of the agitator 48 protruding from the container 10, i.e. in particular the drive device 24 and a part of the drive shaft 48. This is shown in FIG. 3 in the partial view b). The hose 34 in this case with its two open ends is pulled completely over the part of the agitator 18 protruding out of the container 10. In this pushed-together state of the hose 34, it is connected in a fluid-tight manner to the edge of the maintenance opening 30 via a welded connection 32. Secondly, by means of a closure device 36 formed as a constricting device, the end of the hose 34 remote from the container is constricted in a fluid-tight manner about the drive shaft 48. This state is shown in the partial view c). Then by means of a lifting device, not shown, the agitator 18 may be pulled through the maintenance opening 30 out of the container into the position shown in FIG. 3 in the partial view d). In this case, the hose 34 is pulled apart again. As soon as the agitator 18 has been completely pulled out of the container 10 through the maintenance opening 30, the hose 34 in the region of its first end facing the container 10 is in turn completely constricted by means of a constricting device 38. Then the closure device 36 may be opened and the agitator 18 removed for maintenance.

According to the invention, the maintenance of an agitator is possible in a particularly simple and thus cost-effective manner without impairing the operation of the biogas system and with a high degree of flexibility with regard to different types of agitator and container.

This completes the description of the preferred and alternate embodiments of the invention. Those skilled in the art may recognize other equivalents to the specific embodiment described herein which equivalents are intended to be encompassed by the claims attached hereto.

1. A container of a biogas system, comprising a component (18) which may be removed from the container, for example an agitator (18) for mixing substrate (28) located in the container (10), a removal opening (30), as well as a removal device with which the component (18) may be removed at least partially through the removal opening (30) out of the container (10), for example for maintenance purposes, characterised in that
the removal device comprises a flexible hose (34) which may be fastened with its first end to the removal opening (30), such that between the container interior and the hose interior a connection which is fluid-tight relative to the outside is present, through which the component (18) may be at least partially guided into the hose (34),
the removal device comprises a closure device (36) by which the hose (34) may be closed in a fluid-tight manner in the state fastened to the removal opening (30), and
the removal device comprises a constricting device (38) by which the hose (34) may be constricted by reducing the hose cross section in the state fastened to the removal opening (30), when a component (18) is inserted at least partially into the hose (34) in the region of its first end facing the container (10), so that when the hose is closed a space is produced in the hose interior which is fluid-tight relative to the surroundings and at least partially receives the component (18).

2. The container according to claim 1, characterised in that the hose (34) comprises a second opening which may be closed by the closure device (36) in a fluid-tight manner in the state fastened to the removal opening (30) and in that the hose (34) may be constricted by means of the constricting device (38) by reducing the hose cross section in the state fastened to the removal opening (30) when the component (18) is at least partially introduced into the hose (34) in the region of its first end facing the container (10), so that when the second opening is closed the space is produced in the hose interior which is fluid-tight relative to the surroundings and at least partially receives the component (18).

3. The container according to claim 1, characterised in that by means of the closure device (36) the second end of the hose remote from the container interior may be closed in a fluid-tight manner in the state fastened to the removal opening (30), and in that the hose (34) may be constricted by means of the constricting device (38) by reducing the hose cross section in the state fastened to the removal opening (30) when the component (18) is at least partially introduced into the hose (34) in the region of its first end facing the container (10), so that when the second end is closed the space is produced in the hose interior which is fluid-tight relative to the surroundings and at least partially receives the component (18).

4. The container according to claim 1, characterised in that the hose (34) is able to be releasably fastened to the removal opening (30).

5. The container according to claim 1, characterised in that it is possible for the hose (34) to be able to be fastened to the edge of the removal opening (30) by means of a welded connection (32).

6. The container according to claim 1, characterised in that the closure device (36) is also a constricting device with which the hose (34) may be constricted in a fluid-tight manner by reducing the hose cross section, in particular in the region of its second end.

7. The container according to claim 1, characterised in that the closure device (36) is a clamp, with which the hose (34) may be reclosed in a fluid-tight manner, in particular in the region of its second end.

8. The container according to claim 1, characterised in that the closure device (36) is a gas-tight tear closure with which the hose (34) may be reclosed in a fluid-tight manner, in particular in the region of its second end.

9. The container according to claim 1, characterised in that an evacuation device is provided with which the fluid-tight space may be evacuated.

10. The container according to claim 1, characterised in that the at least one constricting device (38) comprises a constricting strap (38) or a constricting clamp.

11. The container according to claim 1, characterised in that the removal opening (30) is arranged in the container wall (14) or in a container cover (16), in particular a film cover (16).

12. A method for at least partially removing a component (18), which may be removed from the container, for example an agitator (18) for mixing substrate (28) located in a container (10) of a biogas system, from the container (10) through a removal opening (30) of the container (10) for example for maintenance purposes, comprising the steps:
a flexible hose (34) is fastened with its first end to the removal opening (30) such that between the container interior and the hose interior a connection is made which is fluid-tight relative to the surroundings,
the hose (34) is closed in a fluid-tight manner,
the component (18) is guided through the removal opening (30) at least partially into the hose (34),
the hose (34) is constricted in the region of its first end facing the container (10) by reducing the hose cross section, when the component (18) is inserted at least partially in the hose (34), so that a space is produced in the hose (34) which is fluid-tight relative to the surroundings and at least partially receives the component (18) and
the hose (34) is opened, so that the component (18) located at least partially in the hose (34) is accessible.

13. The method according to claim 12, characterised in that for closing the hose (34) a second opening of the hose (34) is closed in a fluid-tight manner and that for opening the hose (34) the second opening of the hose (34) is opened, so that the component (18) located at least partially in the hose (34) is accessible.

14. The method according to claim 12, characterised in that for closing the hose (34) the second end of the hose (34) is closed in a fluid-tight manner and for opening the hose (34) the second end of the hose (34) remote from the container interior is opened, so that the component (18) located at least partially in the hose (34) is accessible.

15. The method according to claim 12, characterised in that the hose (34) is releasably fastened to the removal opening (30).

16. The method according to claim 12, characterised in that the hose (34) is welded to the edge of the removal opening (30).

17. The method according to claim 12, characterised in that for closing the hose (34), in particular the second end of the hose (34), the hose (34), in particular in the region of its second end, is constricted in a fluid-tight manner by reducing the hose cross section or is closed by means of a clamp or a gas-tight tear closure in a fluid-tight manner so that it is recloseable.

18. The method according to claim 12, characterised in that after constricting the hose (34) in the region of its first end facing the container (10), the fluid-tight space produced is evacuated, before the hose is opened, in particular the second end of the hose (34) remote from the container interior.

19. The method according to claim 12, characterised in that the component (18) during operation protrudes at least partially from the container (10) and the flexible hose (34) is initially pushed with its two ends over the part of the component (18) protruding from the container (10) and then constricted in the region of its second end around the part protruding from the container (10) and the second end is closed in this manner in a fluid-tight manner.

20. The method according to claim 12, characterised in that the component (18) is removed through a removal opening (30) in the container wall (14) or in a container cover (16), in particular a film cover (16).
